(19) United States
(12) Patent Application Publication
(10) Pub. No.: US 2005/0096898 A1
(43) Pub. Date: May 5, 2005

(54) Classification of speech and music using sub-band energy

(76) Inventor: Manoj Singhal, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/697,620

(22) Filed: Oct. 29, 2003

(51) Int. Cl. G10L 19/14

(52) U.S. Cl. 704/205

(57) ABSTRACT

Disclosed herein is a method and system for classifying an audio signal using a sub-band energy analysis. An audio signal may be received as an input to the system for classifying an audio signal. The audio signal may be passed to a mathematical processor where the mathematical processor may perform a plurality of mathematical processes on the audio signal and calculating a ratio of energy contributable to speech and energy contributable to music. The ratio value R may be output to a comparator. The comparator may compare the calculated ratio R to a threshold value T and based upon the comparison classify the audio signal as one of speech or music.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Human beings, with normal hearing, are often able to distinguish sounds from about 20 Hz, such as the lowest note on a large pipe organ, to 20,000 Hz, such as the high shrill of a dog whistle. Human speech, on the other hand, ranges from 300 Hz to 4,000 Hz.

Music may be produced by playing musical instruments. Musical instruments often produce sounds that lie outside the range of human speech, and in many instances, produce sounds (overtones, etc.) which lie outside the range of human hearing.

An audio communication can comprise either music, speech or both. However, conventional equipment processes audio communication signals comprising only speech in a similar manner as communication signals comprising music.

Further limitations and disadvantages of conventional and traditional approaches will become apparent to one of skill in the art, through comparison of such systems with embodiments presented in the remainder of the present application with references to the drawings.

### SUMMARY OF THE INVENTION

Aspects of the present invention may be found in a method for classifying an audio signal. The method may comprise receiving an audio signal to be classified, dividing the audio signal at least into sub-bands compatible with speech and incompatible with speech, calculating a ratio of the sub-bands energies, comparing the ratio to a threshold value, and classifying the audio signal based upon the comparison.

In another embodiment of the present invention, the method may further comprise performing a Fourier Transform on the audio signal to transform the signal from time to frequency domain.

In another embodiment of the present invention, the method may further comprise squaring the amplitude of the transformed audio signal and associating energy with each frequency component.

In another embodiment of the present invention, calculating a ratio of the sub-bands energies may further comprise integrating the sub-band compatible with speech, integrating the sub-band incompatible with speech, and calculating a ratio of the sub-bands energies.

In another embodiment of the present invention, classifying the audio signal based upon the comparison the ratio to the threshold value may further comprise, if the ratio is less than the threshold value, then the audio signal is classified as speech.

In another embodiment of the present invention, classifying the audio signal based upon the comparison of the ratio to the threshold value may further comprise, if the ratio is greater than the threshold value, then the audio signal is classified as music.

In another embodiment of the present invention, dividing the audio signal into sub-bands compatible with speech and incompatible with speech further comprises dividing the audio signal into a first frequency sub-band comprising frequencies below 4 KHz and a second frequency sub-band comprising frequencies above 4 KHz.

In another embodiment of the present invention, upon classifying the signal as one of speech and music, a classifying sub-band may be further divided and additional ratios calculated to provide more detailed information regarding an identity of a sound producer of the audio signal.

In another embodiment of the present invention, classifying the audio signal occurs prior to encoding the audio signal.

In another embodiment of the present invention, classifying the audio signal occurs after decoding the audio signal.

In another embodiment of the present invention, the method may further comprise converting the audio signal from an analog signal to a digital signal, encoding the audio signal, packetizing the audio signal, transmitting the audio signal, decoding the audio signal, and processing the audio signal. Processing may also at least comprise one of storing the audio signal and playing the audio signal.

In another embodiment of the present invention, the threshold value used in the comparison is pre-determined and pre-set by a user.

In another embodiment of the present invention, the threshold value used in the comparison is determined through trial and error of a plurality of iterations in a comparing device.

In another embodiment of the present invention, classifying the audio signal further comprises turning on a flag in a header of a packet of digital audio information, wherein the flag provides an indication of classification of the audio signal based upon comparison of the ratio and the threshold value.

In another embodiment of the present invention, the audio signal is one of an analog signal and a digital signal.

Aspects of the present invention may also be found in a system for classifying an audio signal. The system may comprise an input for receiving an audio signal, a mathematical processor for performing a plurality of mathematical functions on the audio signal, a comparator for comparing a calculated ratio of sub-bands energies of the audio signal to a threshold value, and an output indicating a classification of the audio signal.

In another embodiment of the present invention, the plurality of mathematical functions performed on the audio signal may comprise at least one of a Fourier Transform, squaring an amplitude, separating an audio spectrum into various sub-bands of different sizes, integrating the sub-bands, and calculating a ratio of integrated sub-bands energies.

In another embodiment of the present invention, the comparator may be programmed with the threshold value by a user.

In another embodiment of the present invention, the comparator may determine the threshold value through a plurality of comparative iterations.

In another embodiment of the present invention, the output may comprise turning on a flag in a header in a packet of digital information, wherein the flag may be used to determine whether the audio signal is mathematically processed further or directed to a receiver.

In another embodiment of the present invention, the comparator may be adapted to classify the audio signal based upon the comparison the ratio to the threshold value, wherein if the ratio is less than the threshold value, then the audio signal is classified as speech.

In another embodiment of the present invention, the comparator may be adapted to classify the audio signal based upon the comparison of the ratio to the threshold value wherein, if the ratio is greater than the threshold value, then the audio signal is classified as music.

In another embodiment of the present invention, upon classifying the signal as one of speech and music, a dominant classifying sub-band may be further divided to provide more detailed information regarding an identity of a producer of the audio signal.

These and other advantages and novel features of the present invention, as well as details of an illustrated example embodiment thereof, will be more fully understood from the following description and drawings.

### BRIEF DESCRIPTION OF THE DRAWINGS

FIG. 1. illustrates a portion of an audio communication received by an electronic device according to an embodiment of the present invention;

FIG. 2 illustrates a portion of an analog audio signal according to an embodiment of the present invention;

FIG. 3 illustrates a portion of an analog audio signal being sampled for conversion to a digital signal according to an embodiment of the present invention;

FIG. 4 illustrates a portion of a digital audio signal according to an embodiment of the present invention;

FIG. 5 is a graph illustrating the audio communication after Fourier Transformation shown in terms of the absolute value of the amplitude versus frequency according to an embodiment of the present invention;

FIG. 6 is a graph illustrating the audio communication after further manipulation shown in terms of the amplitude squared, which approximates the energy of the signal, versus frequency according to an embodiment of the present invention;

FIG. 7 is a flow chart illustrating a method for classifying an audio signal as one of speech or music according to an embodiment of the present invention;

FIG. 8 illustrates an apparatus for classifying an audio signal as one of speech or music using sub-band energy analysis according to an embodiment of the present invention;

FIG. 8A is a flow chart illustrating a method for classifying an audio signal as speech or music using sub-band energy according to an embodiment of the present invention;

FIG. 8B is a block diagram illustrating a system for converting, classifying, encoding, and packetizing an audio communication according to an embodiment of the present invention;

FIG. 8C is a block diagram illustrating encoding of an exemplary audio signal A(t) according to an embodiment of the present invention; and

FIG. 9 is a block diagram illustrating an exemplary audio decoder according to an embodiment of the present invention.

### DETAILED DESCRIPTION OF THE INVENTION

Modern electronic devices are adapted for transmitting and receiving both music and speech. In a broadband communication, any interruption of music transmission, such by speech transmission, may be interpreted as a commercial or an advertisement.

An aspect of the present invention may be found in a method and system for classifying whether a communication received is speech or music by applying a sub-band energy analysis method to the communication.

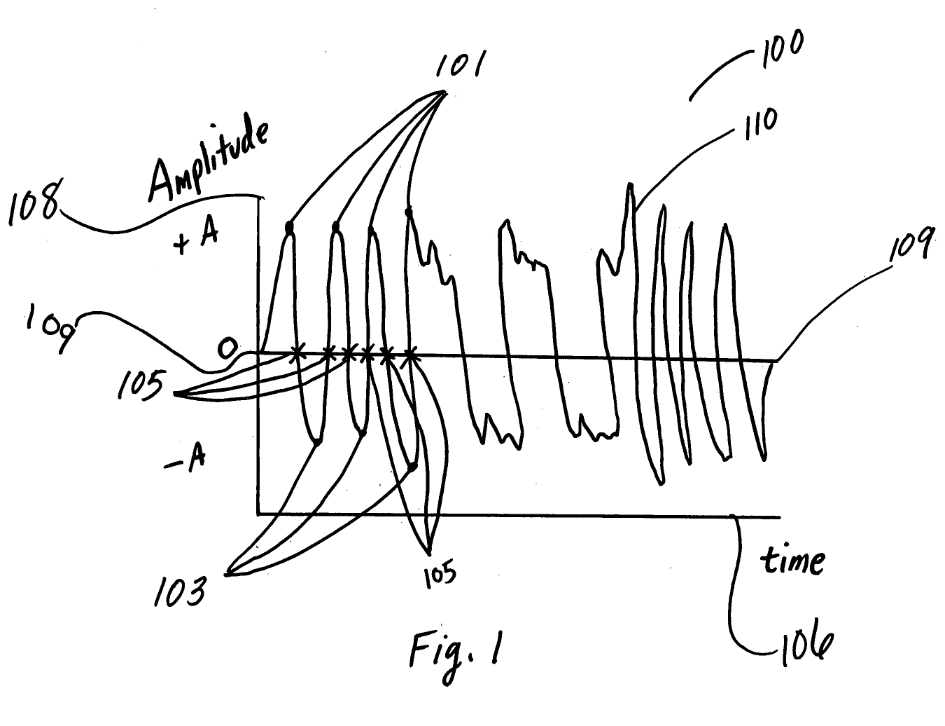

FIG. 1 illustrates a portion 100 of an audio communication 110 received by an electronic device according to an embodiment of the present invention. The audio communication 110 comprises an analog or digital audio signal having a bandwidth or spectrum. The audio communication 110 oscillates between positive amplitude 101 and negative amplitude 103, crossing a zero point 109 (zero point crossings 105 marked by X's) as each oscillation transitions from positive to negative values. The audio communication 110 is illustrated in terms of the amplitude 108 (Y-Axis) with respect to time 106 (X-axis).

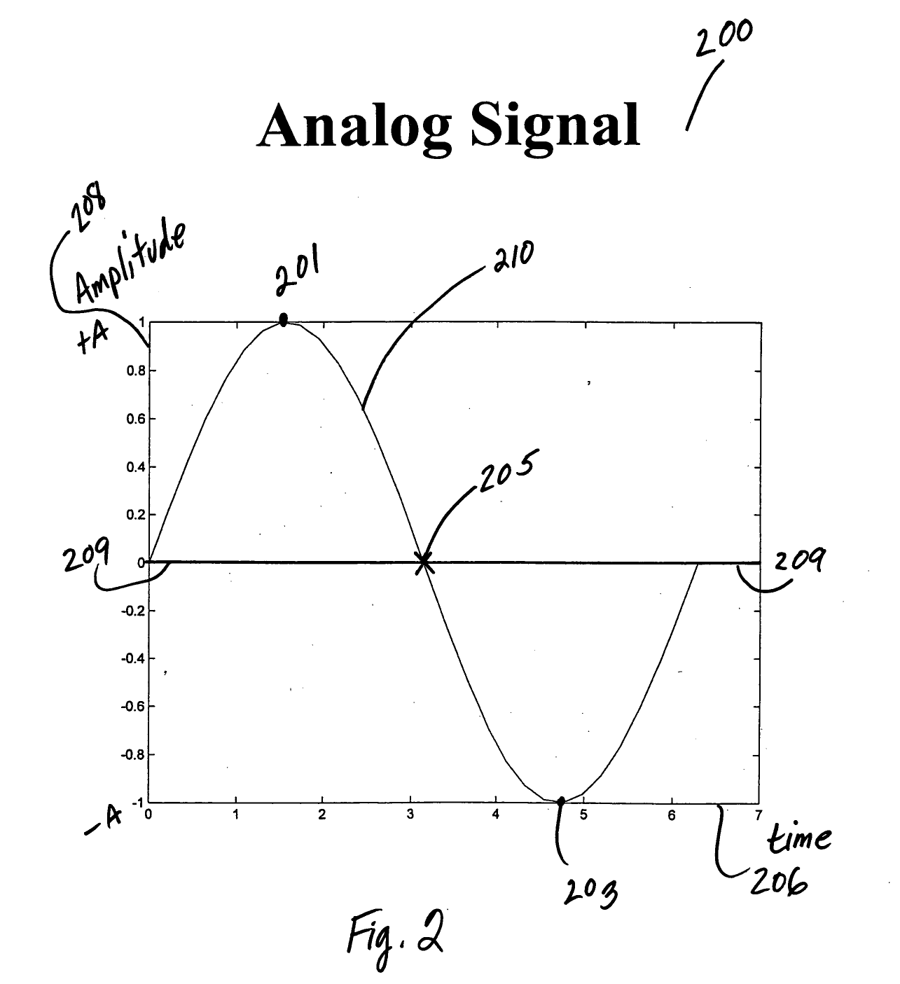

FIG. 2 illustrates a portion 200 of an analog audio signal 210 according to an embodiment of the present invention. The analog audio signal 210 comprises a bandwidth or spectrum. The analog audio signal 210 oscillates between a positive amplitude 201 and a negative amplitude 203, crossing a zero point 209 (the zero point crossing 205 marked by an X) as each oscillation transitions from positive to negative values. The analog audio signal 210 is illustrated in terms of the amplitude 208 (Y-Axis) with respect to time 206 (X-axis).

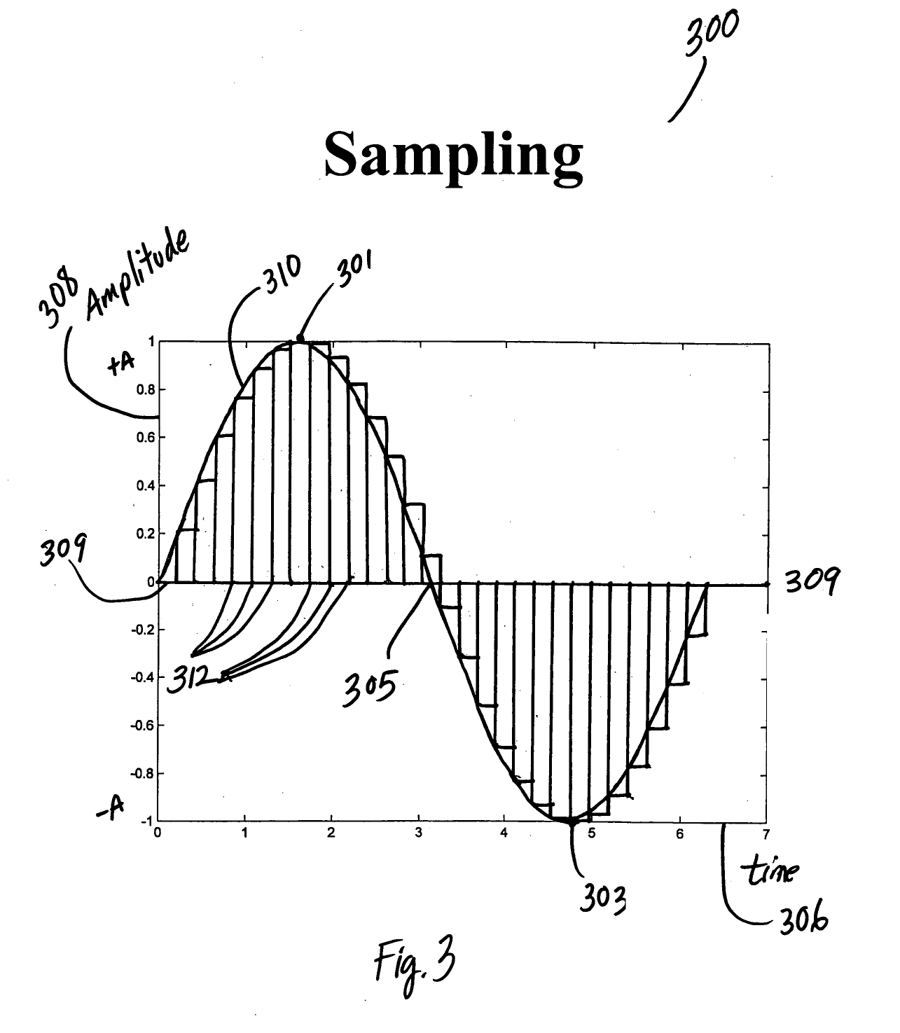

FIG. 3 illustrates a portion 300 of an analog audio signal 310 being sampled for conversion to a digital signal according to an embodiment of the present invention. The audio signal 310 comprises a bandwidth or spectrum and has been divided into a plurality of discrete samples 312. The samples 312 approximate the analog audio signal 310. The analog audio signal 310 oscillates between a positive amplitude 301 and a negative amplitude 303, crossing a zero point 309 (the zero point crossing 305 marked by an X) as each oscillation transitions from positive to negative values. The sampled audio signal 310 is illustrated in terms of the amplitude 308 (Y-Axis) with respect to time 306 (X-axis).

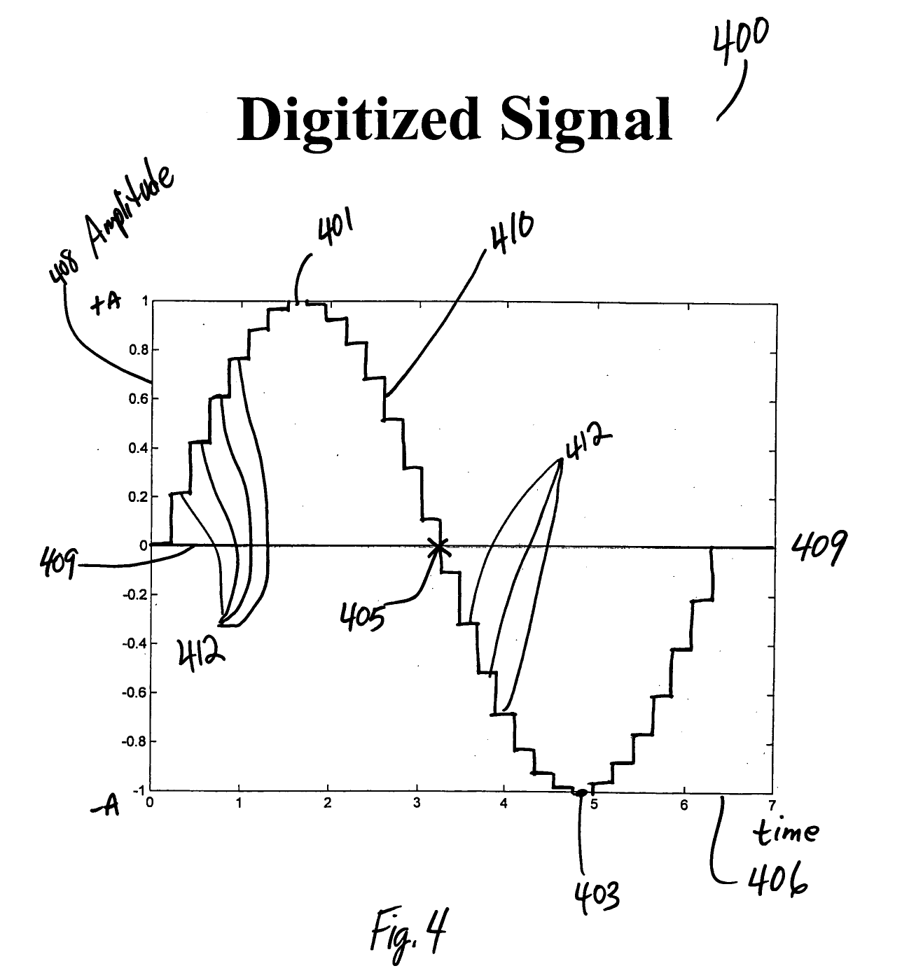

FIG. 4 illustrates a portion 400 of a digital audio signal 410 according to an embodiment of the present invention. The digital audio signal 410 comprises a bandwidth or spectrum and is shown approximating the analog signal 210 through a plurality of quantized discrete samples 412. The digital audio signal 410 transitions through a positive amplitude 401 and a negative amplitude 403 over time, crossing a zero point 409 (the zero point crossing 405 marked by an X). The digital audio signal 410 is illustrated in terms of the quantized amplitude 408 (Y-Axis) with respect quantized time 406 (X-axis).

A digital audio signal is an audio signal using binary code to represent audio information. Much of the analog behavior of the audio signal is ignored and the signals are modeled so that the information being transmitted is translated into a series of zeros and ones, i.e., a range of analog values are associated with a logical value. Digital systems process time varying signals that can take on any value quantized from a continuous range of electrical values. The digital audio transmission system takes the audio information and represents it as a series of bits represented in code by zeros and ones.

On the other hand, an analog audio communication is a way of sending signals in which the communicated audio signal is a wave reflecting the original signal. An analog audio communication system attempts to recreate the audio information as it actually happens. Analog systems process time varying signals that can take any value across a continuous electrical values.

Human beings with normal hearing can detect sounds from about 20 Hz to about 20,000 Hz. Human speech, on the other hand, ordinarily ranges from about 300 Hz to about 4,000 Hz. Music produces audible sounds that lie outside the range of human speech (20 to 20,000 Hz) but within the range of human hearing (300 to 4,000 Hz).

There are various reasons for determining whether the audio communication is associated with speech or music. For example, it may be advantageous to process audio communications associated with speech in one manner and audio communications associated with music in another manner.

Whether the audio communication is associated with speech or music can be determined by measuring the sub-band energy of the audio signal across a particular spectrum of frequencies. The greater the energy in the higher part of the spectrum in comparison to the lower part of the spectrum, the greater the likelihood that the audio communication is associated with music. While on the other hand more the energy in the lower part of the spectrum in comparison to higher part of the spectrum, the greater the likelihood that the audio communication is associated with speech.

Accordingly, the sub-band energy of the audio signal across a particular spectrum of frequencies can be compared to a threshold value. If the sub-band energy of the audio signal across a particular part of the spectrum of frequencies exceeds a predetermined threshold value, a determination can be made that the audio communication is associated with music. If the threshold value exceeds the sub-band energy of the audio signal across a particular spectrum of frequencies, a determination may be made that the audio communication is associated with speech.

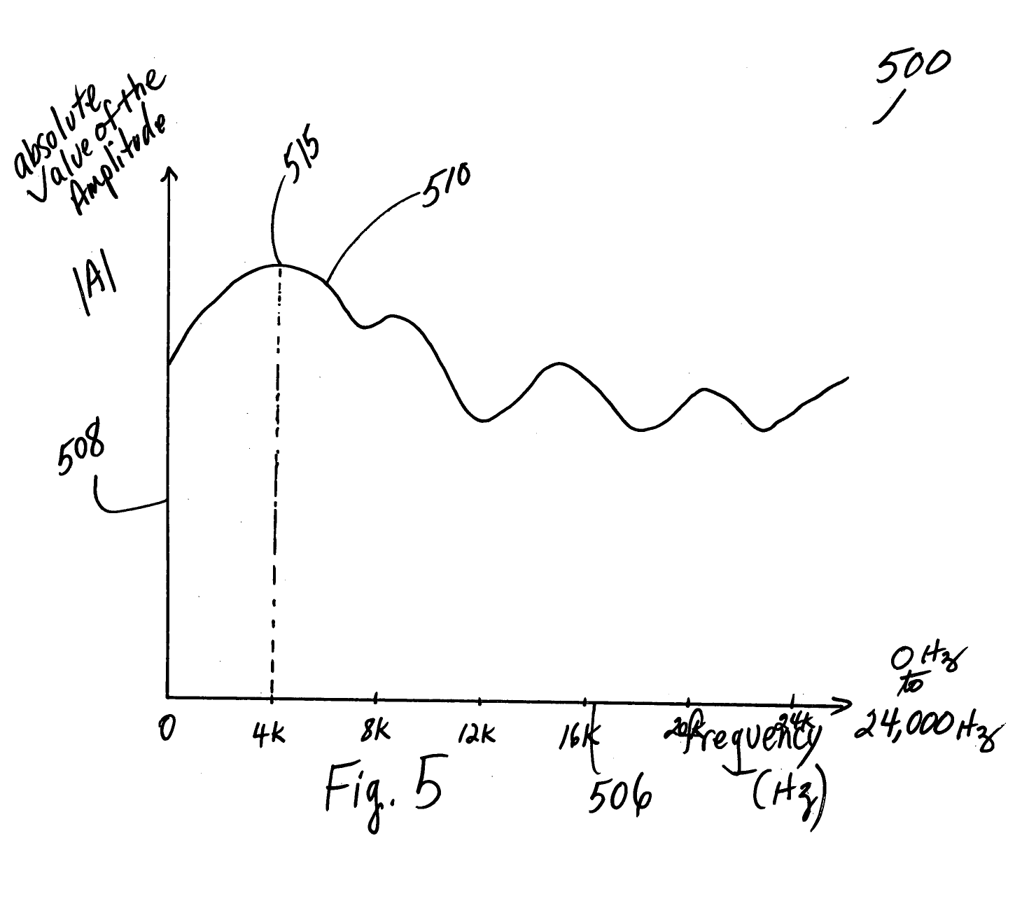

FIG. 5 is a graph 500 illustrating the audio communication 510 after Fourier Transformation shown in terms of the absolute value of the amplitude versus frequency according to an embodiment of the present invention. In FIG. 5, the absolute value of the amplitude 508 (Y-axis) is graphed with respect to the frequency 506 (X-axis). The time component of the audio signal is transformed to a frequency component through application of the Fourier Transform. The transformed audio signal 510 comprises a bandwidth or spectrum. The bandwidth or spectrum may be from 0 to at least 24 KHz, for example. The 4 KHz position 515 is illustrated by a dotted line.

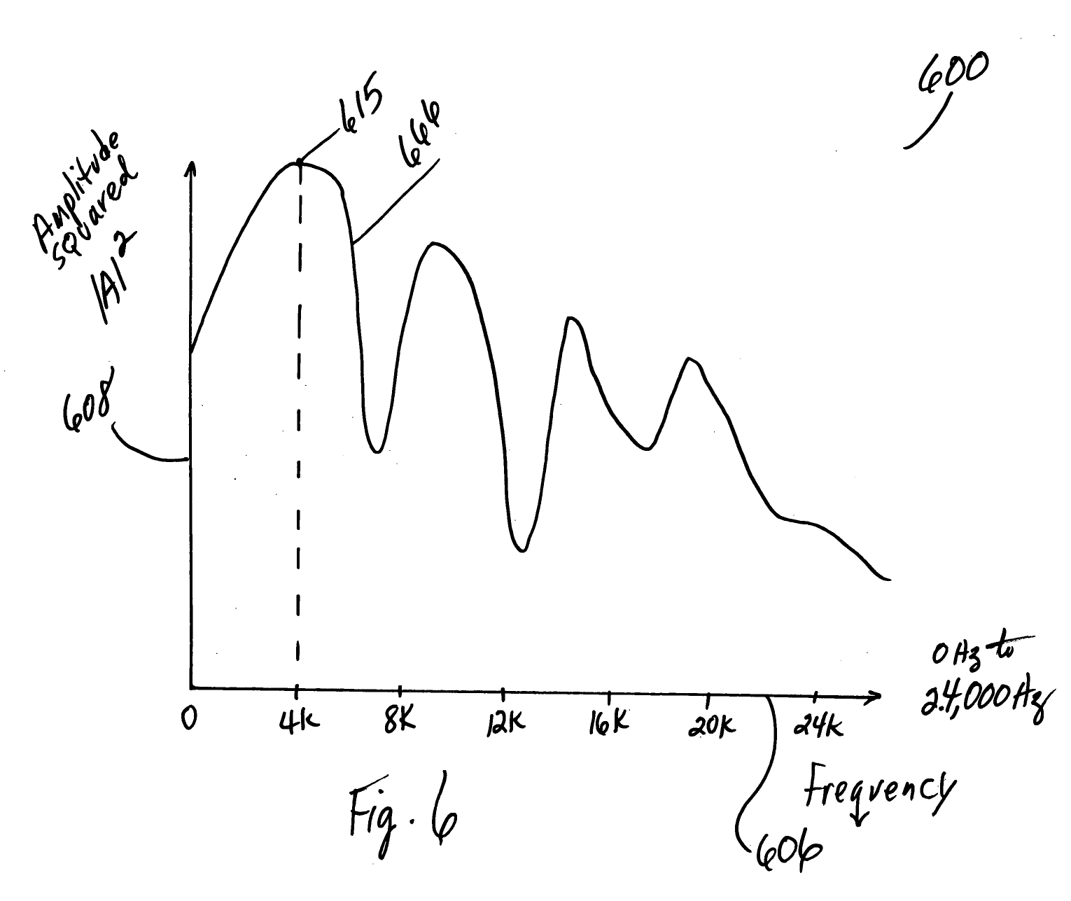

FIG. 6 is a graph 600 illustrating the audio communication 666 after further manipulation shown in terms of the amplitude squared (which approximates the energy of the signal) versus frequency according to an embodiment of the present invention. The amplitude squared 608 A²(Y-axis) is related to the energy E of the audio signal 666, where A is the amplitude, and E is the energy. The squared amplitude is proportionally related to the energy of the signal. Here, the 4 KHz position 615 has been indicated by the dashed line.

The manipulated and transformed audio signal (such as audio communication 666 shown in FIG. 6) may also comprise a bandwidth or spectrum. For example from 0 to 24 KHz. Because human speech ranges from 300 Hz to 4,000 Hz (i.e., only a portion the spectrum of the audio signal) in order to classify the audio signal 666 as being one of speech or music, a ratio of the energy across particular sub-bands of the entire spectrum may be calculated.

The calculation may take the following form:

$$\frac{{\int }_{0}^{4 KHz} {A}^{2} ⅆ A}{{\int }_{4 KHz}^{24 KHz} {A}^{2} ⅆ A} = R$$

where the numerator provides the energy of the sub-band of the audio signal 666 compatible with human speech, and the denominator provides the energy of the sub-band of the audio signal 666 lying outside the range of and being incompatible with human speech, and R is the ratio of the two sub-bands energies. It is noted that the proportional relationship between A² and E is cancelled out in the above equation. Integrating the energy across a particular frequency range provides the total energy of the signal within the particular frequency range. Thus, the ratio R is a ratio of the total energy of the frequency range compatible with speech divided by the total energy of the frequency range incompatible with speech.

While the energy value of the sub-bands has been shown calculated using the square of the amplitude, the amplitude may be used unmodified (such as in FIG. 5) in another embodiment of the invention to calculate the ratio of the sub-bands.

The calculated ratio R, either using squared amplitude or the absolute value of the amplitude, may then be passed to a comparator, where R is compared to a predetermined threshold value T. If R is greater than T, then the audio signal may be classified as music, for example. However, if R is less than T, then the audio signal may be classified as speech, for example.

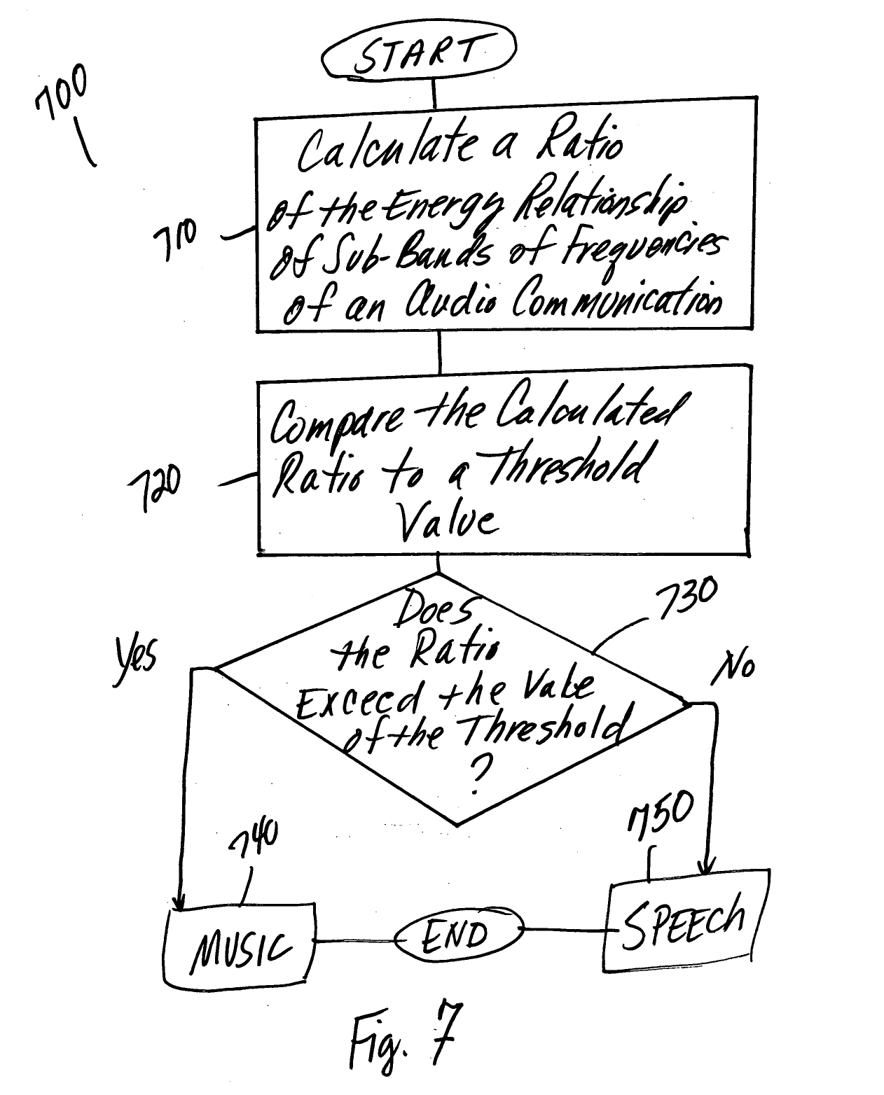

FIG. 7 is a flow chart 700 illustrating a method for classifying an audio signal as one of speech or music according to an embodiment of the present invention. At 710, a ratio is calculated wherein the ratio characterizes the relationship between sub-bands having various ranges of frequencies and being part of an audio communication. At 720, the ratio may be compared to a threshold value. At 730, it is determined whether the ratio exceeds the value of the threshold. If the ratio exceeds the threshold value, then the signal may be characterized as music (740), however, if the ratio does not exceed the threshold value, the audio signal may be characterized as speech (750).

A comparator may be programmed with the threshold value by a user or may learn the threshold value through a plurality of trial and error iterations. Because, the threshold value is a ratio of energies, the threshold value can go from 0 to a very high value which can be fine tuned by doing trial and error iterations.

Upon classifying the audio signal, a flag may be turned on in a header of a packet of digital information indicating whether the audio signal has been classified as speech or music. Based upon the flag in the header, the audio signal may be directed for additional manipulation or directed to a receiver based upon the classification of the audio signal.

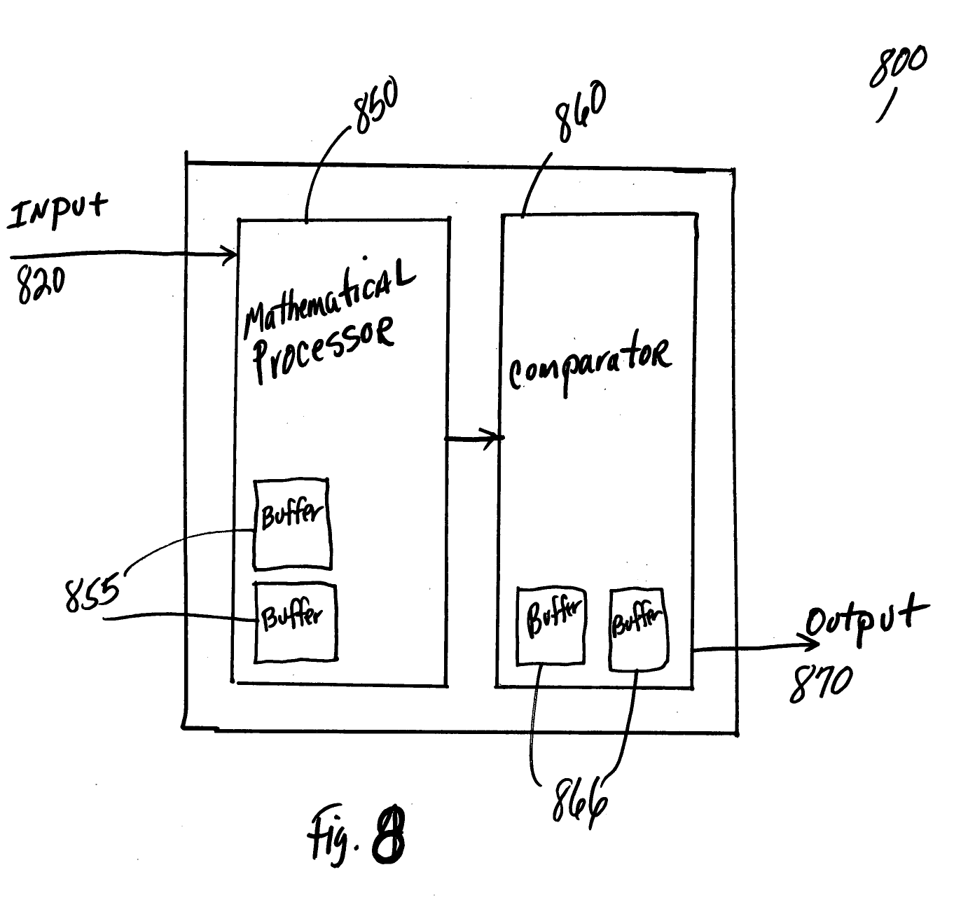

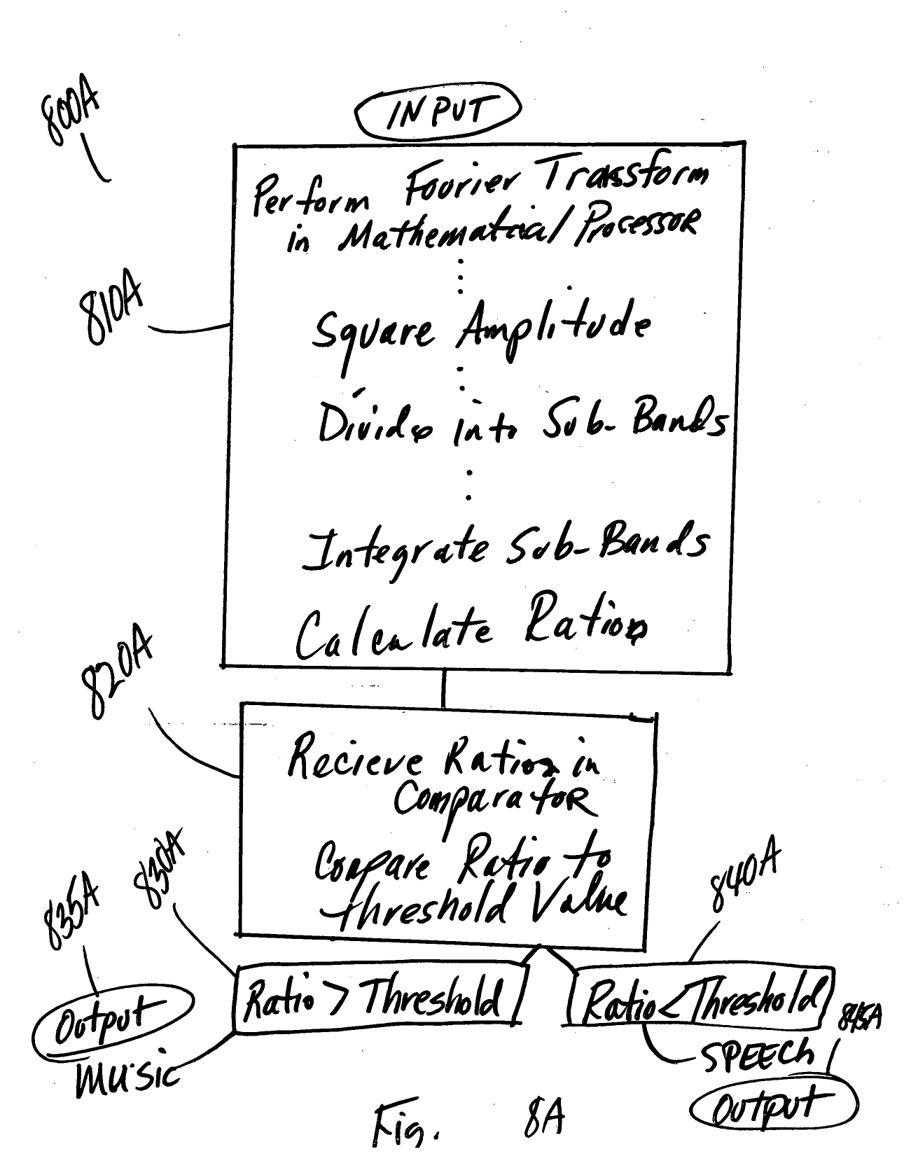

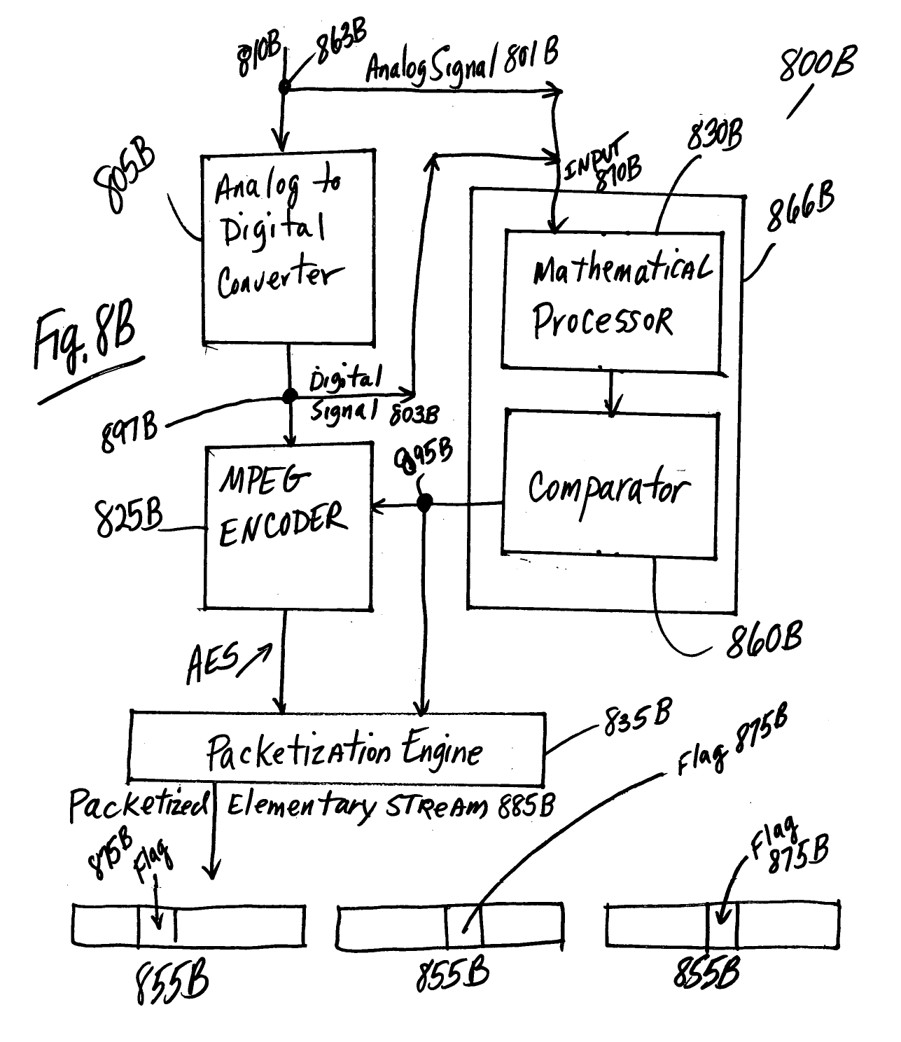

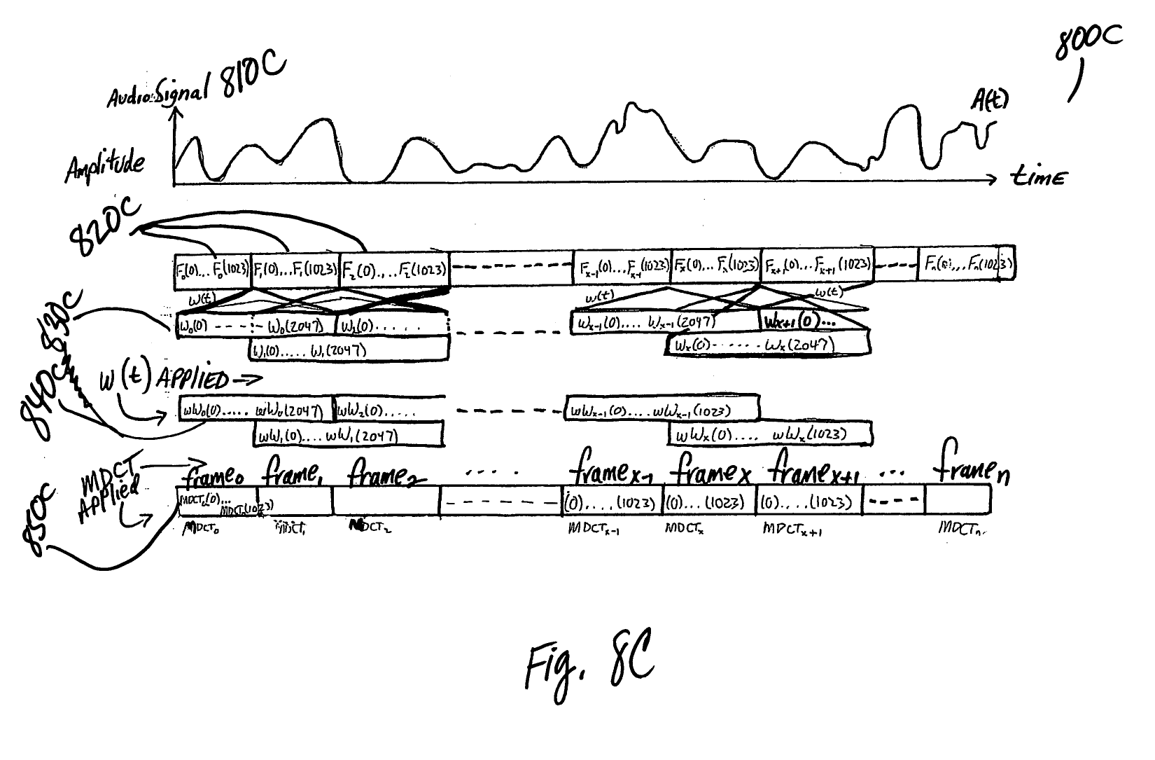

FIG. 8 illustrates an apparatus 800 for classifying an audio signal as one of speech or music using sub-band energy analysis according to an embodiment of the present invention. In FIG. 8, in order to classify the audio signal illustrated in one of FIGS. 5 or 6 as speech or music, the audio signal may be passed through an input 820 to a mathematical processor 850 for processing. The mathematical processor may comprise one or more buffers 855 for temporarily storing audio information and audio components during the mathematical processing.

In the mathematical processor 850, a Fourier Transform may be performed on the audio signal. The mathematical processor may comprise one or more buffers 855 for storing audio signal information during mathematical processing and the Fourier Transformation. The mathematical processor 850 may then square the amplitude of the audio signal across the entire spectrum. The audio signal may then be divided into sub-bands, wherein at least one sub-band is compatible with human speech and at least another sub-band may be incompatible with human speech. The sub-bands may be integrated and a ratio therebetween calculated in the mathematical processor 850.

The mathematical processor 850 may be adapted to divide the audio signal into even finer discrimination. For example, if the audio signal is determined to be speech, the frequency range compatible with human speech may be further divided and a different ratio calculated to determine if the speech is male speech, female speech, adult speech, child speech based upon the energy of the audio signal in a particular corresponding frequency range.

Additionally, if the signal is determined to be music, the frequency range incompatible with human speech may be further divided and a different ratio calculated to determine what instrument(s) are making the music based upon the energy of the signal in a particular corresponding frequency range.

In general, the dominant classifying sub-band, as determined from the comparison of the ratio R to the threshold value T, may be further divided and mathematically analyzed to glean additional information about the identity of the producer of the sound represented by the audio signal.

The mathematical processor 850 may pass the ratio value R to a comparator 860 for comparison with the threshold value T. The comparator 860 may be provided with one or more buffers for storing audio information and audio components during the comparison. The threshold value T may be predetermined and provided by a user, or the threshold value T may be learned (i.e., determined) through a training process in the comparator 860, wherein the comparator 860 through trial and error is adapted to determine the threshold value T. The comparator 860 compares the ratio value R to the threshold value T and outputs a classification of the audio signal as being one of music or speech.

FIG. 8A is a flow chart 800A illustrating a method for classifying an audio signal as speech or music using sub-band energy according to an embodiment of the present invention. In FIG. 8A an audio signal is received as an input to the apparatus for classifying an audio signal. The audio signal may be passed to a mathematical processor 850 where the mathematical processor 850 may perform one or more of the following: (810A) a Fourier Transform of the audio signal; squaring the amplitude of the audio signal; divide the spectrum of the signal into speech compatible and speech incompatible sub-bands; integrating the sub-bands; calculating a ratio of the energy of the sub-bands; and outputting the ratio value R to a comparator 860.

The comparator 860 may receive and compare the calculated ratio R to a threshold value T 820A and based upon the comparison, classify the audio signal as one of speech or music. If the ratio is greater than the threshold value 830A, then the comparator 860 may output that the audio signal is music 835A. If the ratio is less than the threshold value 840A, then the comparator 860 may output that the audio signal is speech 845A.

Upon classifying the audio signal, a flag may be turned on in a header of a packet of digital information indicating whether the audio signal has been classified as speech or music. Based upon the flag in the header, the audio signal may be directed for additional manipulation or directed to a receiver based upon the classification of the audio signal.

The threshold value may be predetermined and provided by a user, or alternatively may be learned through a training process in the comparator 860, wherein the comparator 860, through trial and error, may determine the threshold value. The comparator 860 may compare the ratio to the threshold value and output a classification of the audio signal as being one of music or speech.

An audio signal comprising speech has less energy, and thus a lower ratio, because speech is generally filled with a plurality of silent time periods, where the speaker completes words, takes in breath, etc. Alternatively, an audio signal comprising music is generally more energetic because the audio signal is continuously filled over time, and because the instrument(s) continue to produce sound for longer time periods, in contrast to speech.

FIG. 8B is a block diagram illustrating a system 800B for converting, classifying, encoding, and packetizing an audio communication according to an embodiment of the present invention. In FIG. 8B, the system 800B receives an audio communication 810B, wherein the audio communication 810B may be either an analog signal 801B or a digital signal 803B. The audio communication 810B may proceed directly to speech/music classification apparatus 866B as an analog signal 801B at junction 863B. Alternatively, the audio signal 810B may be passed through analog to digital converter 805B for conversion to a digital signal 803B that is provided via junction 797 to the speech/music classification apparatus 866B. After conversion from analog to digital, the digital signal 803B may be passed to MPEG encoder 825B. The circumstances of the audio signal processing at the MPEG encoder 852B will be described below.

The audio signal may arrive at the speech/music classifying apparatus 866B at input 820B. The signal is then passed to mathematical processor 830B. After the mathematical processing has completed and the ratio determined, the ratio is passed to comparator 860B. Comparator 860B is adapted to compare the calculated ratio to the threshold value. The threshold value may be pre-set by a user, or the comparator 860B may determine (learn) the threshold value through trial and error. If the ratio is greater than the threshold value, then the output from the speech/music classifying apparatus 866B is that the audio signal is determined to be music. However, if the ratio is less than the threshold value, then the output from the classifying apparatus 866B is that the audio signal is speech.

The signal may then be passed to either MPEG encoder 825B or alternatively to packetization engine 835B via junction 895B. The MPEG encoder 825B converts the digital signal 803B to an audio elementary stream (AES), AES encoding the digital signal 803B in accordance with the MPEG standard. When the AES is directed to the packetization engine 835B, the AES is packetized into a packetized audio elementary stream comprising packets 855B. Each packet comprising a portion of the AES and may also comprise a flag 875B. The flag 875B may indicate that the portion of the AES in the packet is speech or music depending upon the state of the flag 875B, i.e., whether the flag is turned on or off.

FIG. 8C is a block diagram 800C illustrating encoding of an exemplary audio signal A(t) 810C by the MPEG encoder 825B according to an embodiment of the present invention. The audio signal 810C is sampled and the samples are grouped into frames 820C (F₀ . . . Fₙ) of 1024 samples, e.g., (Fₓ(0) . . . Fₓ(1023)). The frames 820C (F₀ . . . Fₙ) are grouped into windows 830C (W₀ . . . Wₙ) that comprise 2048 samples or two frames, e.g., (Wₓ(0) . . . Wₓ(2047)). However, each window 830C Wₓ has a 50% overlap with the previous window 830C Wₓ₋₁.

Accordingly, the first 1024 samples of a window 830C Wₓ are the same as the last 1024 samples of the previous window 830C Wₓ₋₁. A window function w(t) is applied to each window 830C (W₀ . . . Wₙ), resulting in sets (wW₀ . . . wWₙ) of 2048 windowed samples 840C, e.g., (wWₓ(0) . . . wWₓ(2047)). The modified discrete cosine transformation (MDCT) is applied to each set (wW₀ . . . wWₙ) of windowed samples 840C (wWₓ(0) . . . wWₓ(2047)) resulting sets (MDCT₀ . . . MDCTₙ) of 1024 frequency coefficients 850C, e.g., (MDCTₓ(0) . . . MDCTₓ(1023)) .

The MPEG encoder 825B receives the output of the speech/music classification 866B apparatus. Based upon the output of the speech/music classification apparatus 866B, the MPEG encoder 825B can take any number of actions with respect to the MDCT coefficients. For example, where the output indicates that the content associated with the audio signal 810C is speech, the MPEG encoder 825B can either discard or quantize with fewer bits the MDCT coefficients associated with frequencies outside the range of human speech, i.e., exceeding 4 KHz. Where the output indicates that the content associated with the audio signal 810C is music, the MPEG encoder 825B can quantize the MDCT coefficients associated with frequencies outside the range of human speech.

The sets of frequency coefficients 850C (MDCT₀ . . . MDCTₙ) are then quantized and coded for transmission, forming what is known as an audio elementary stream (AES). The AES can be multiplexed with other AESs. The multiplexed signal, known as the Audio Transport Stream (Audio TS) can then be stored and/or transported for playback on a playback device. The playback device can either be local or remotely located.

Where the playback device is remotely located, the multiplexed signal is transported over a communication medium, such as the internet. During playback, the Audio TS is de-multiplexed, resulting in the constituent AES signals. The constituent AES signals are then decoded, resulting in the audio signal.

Alternatively, the frequency coefficients MDCT₀ . . . MDCTₙ may be packetized by the packetization engine of FIG. 8B. In an audio signal, each frame may comprise frequency coefficients 850C (MDCT₀ . . . MDCT₁₀₂₃). Sub-frame contents may correspond to a particular range of audio frequencies.

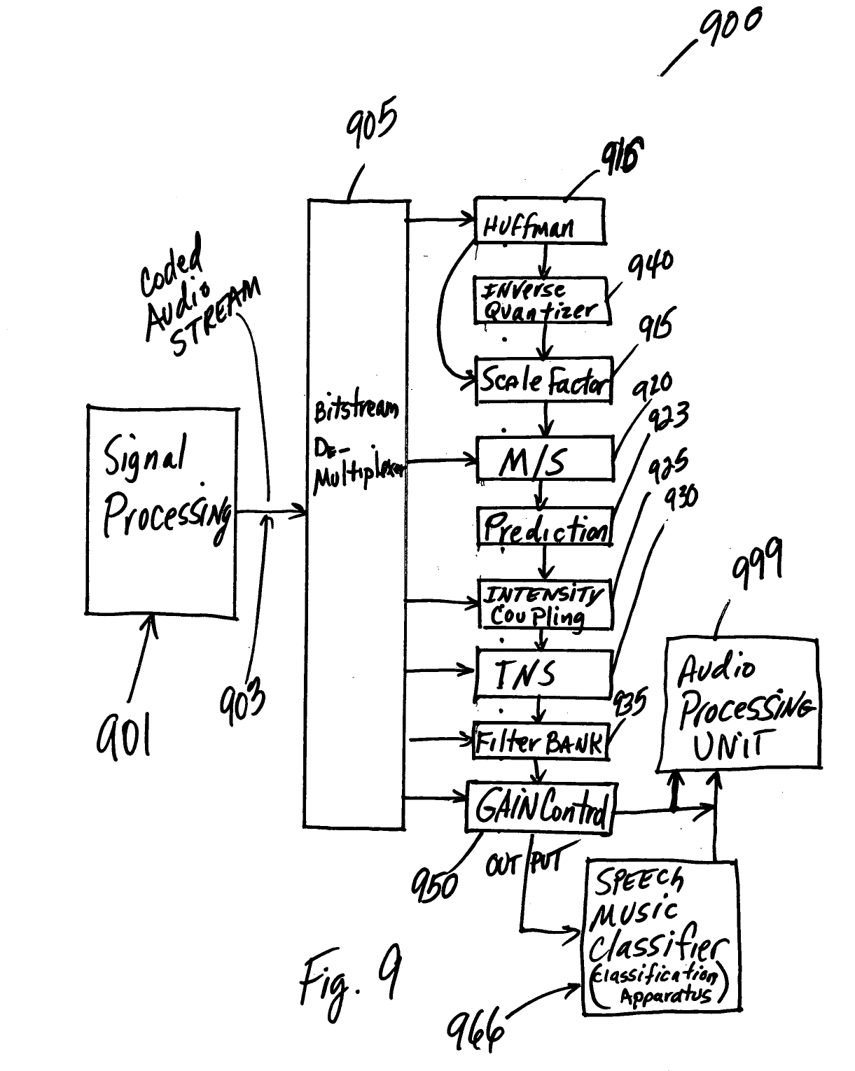

FIG. 9 is a block diagram illustrating an exemplary audio decoder 900 according to an embodiment of the present invention. Referring now to FIG. 9, once the frame synchronization is found and delivered from signal processor 901, the advanced audio coding (AAC) bitstream 903 is de-multiplexed by a bitstream de-multiplexer 905. This includes Huffman decoding 916, scale factor decoding 915, and decoding of side information used in tools such as mono/stereo 920, intensity stereo 925, TNS 930, and the filterbank 935.

The sets of frequency coefficients 850C (MDCT₀ . . . MDCTₙ) are decoded and copied to an output buffer in a sample fashion. After Huffman decoding 916, an inverse quantizer 940 inverse quantizes each set of frequency coefficients 850C (MDCT₀ . . . MDCTₙ) by a 4/3 power nonlinearity. The scale factors 915 are then used to scale sets of frequency coefficients 850C (MDCT₀ . . . MDCTₙ) by the quantizer step size.

Additionally, tools including the mono/stereo 920, prediction 923, intensity stereo coupling 925, TNS 930, and filterbank 935 can apply further functions to the sets of frequency coefficients 850C (MDCT₀ . . . MDCTₙ). The gain control 950 transforms the frequency coefficients 850C (MDCT₀ . . . MDCTₙ) into the time domain signal A(t). The gain control 950 transforms the frequency coefficients 850C by application of the Inverse MDCT (IMDCT), the inverse window function, window overlap, and window adding. The gain control 950 also looks at the flag 875B. The flag 875B is a bit that may be either on or off, i.e., having binary digital value of 1 or zero, respectively. For example, if the bit is on, this indicates that the audio signal is music, and if the bit is off, this indicates that the audio signal is speech, or vice versa.

If the flag 875B indicates that the audio signal is music the gain control and may then perform the decoding by performing the Inverse MDCT function. The gain control 950 may also report results directly to the audio processing unit 999 for additional processing, playback, or storage. The gain control 950 is adapted to detect at the receiving/decoding end of the audio transmission whether the audio signal is one of music or speech.

Another music/speech classifier 966, such as the speech/music classifier 800 disclosed in FIG. 8, may be provided at the decoder 900, so that in the circumstance where the signal has been received at the decoder 900 without being classified as one of speech or music, the signal may then be classified. The signal may also be passed to an audio processing unit 999 for storage, playback, or further analysis, as desired.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for classifying an audio signal, the method comprising:
receiving an audio signal to be classified;
dividing the audio signal at least into sub-bands compatible with speech and incompatible with speech;
calculating a ratio of the sub-bands energies;
comparing the ratio to a threshold value; and
classifying the audio signal based upon the comparison.

2. The method according to claim 1, further comprising performing a Fourier Transform on the audio signal to transform the signal from time to frequency.

3. The method according to claim 2, further comprising squaring the amplitude of the transformed audio signal and associating energy with frequency.

4. The method according to claim 1, wherein calculating a ratio of the sub-bands further comprises integrating the sub-band compatible with speech, integrating the sub-band incompatible with speech, and calculating a ratio of the sub-bands energies.

5. The method according to claim 1, wherein classifying the audio signal based upon the comparison the ratio to the threshold value further comprises,
if the ratio is less than the threshold value, then the audio signal is classified as speech.

6. The method according to claim 1, wherein classifying the audio signal based upon the comparison of the ratio to the threshold value further comprises,
if the ratio is greater than the threshold value, then the audio signal is classified as music.

7. The method according to claim 1, wherein dividing the audio signal into sub-bands compatible with speech and incompatible with speech further comprises dividing the audio signal into a first frequency sub-band comprising frequencies below 4 KHz and a second frequency sub-band comprising frequencies above 4 KHz.

8. The method according to claim 1, wherein upon classifying the signal as one of speech and music, a classifying sub-band may be further divided and additional ratios calculated to provide more detailed information regarding an identity of a sound producer of the audio signal.

9. The method according to claim 1, wherein classifying the audio signal occurs prior to encoding the audio signal.

10. The method according to claim 1, wherein classifying the audio signal occurs after decoding the audio signal.

11. The method according to claim 1, further comprising:
converting the audio signal from an analog signal to a digital signal;
encoding the audio signal;
packetizing the audio signal;
transmitting the audio signal;
decoding the audio signal; and
processing the audio signal, wherein processing at least comprises one of storing the audio signal and playing the audio signal.

12. The method according to claim 1, wherein the threshold value used in the comparison is pre-determined and pre-set by a user.

13. The method according to claim 1, wherein the threshold value used in the comparison is determined through trial and error of a plurality of iterations in a comparing device.

14. The method according to claim 1, wherein classifying the audio signal further comprises turning on a flag in a header of a packet of digital audio information, wherein the flag provides an indication of classification of the audio signal based upon comparison of the ratio and the threshold value.

15. The method according to claim 1, wherein the audio signal is one of an analog signal and a digital signal.

16. A system for classifying an audio signal, the system comprising:
an input for receiving an audio signal;
a mathematical processor for performing a plurality of mathematical functions on the audio signal;
a comparator for comparing a calculated ratio of sub-bands of energy of the audio signal to a threshold value; and
an output indicating a classification of the audio signal.

17. The system according to claim 16, wherein the plurality of mathematical functions performed on the audio signal may comprise at least one of a Fourier Transform, squaring an amplitude, separating an audio spectrum into sub-bands, integrating the sub-bands, and calculating a ratio of integrated sub-bands.

18. The system according to claim 16, wherein the comparator may be programmed with the threshold value by a user.

19. The system according to claim 16, wherein the comparator may determine the threshold value through a plurality of comparative iterations.

20. The system according to claim 16, wherein the output-may comprise turning on a flag in a header in a packet of digital information, wherein the flag may be used to determine whether the audio signal is mathematically processed further or directed to a receiver.

21. The system according to claim 16, wherein the comparator is adapted to classify the audio signal based upon the comparison the ratio to the threshold value wherein, if the ratio is-less than the threshold value, then the audio signal is classified as speech.

22. The system according to claim 16, wherein the comparator is adapted to classify the audio signal based upon the comparison of the ratio to the threshold value wherein, if the ratio is greater than the threshold value, then the audio signal is classified as music.

23. The system according to claim 16, wherein upon classifying the signal as one of speech and music, a dominant classifying sub-band may be further divided to provide more detailed information regarding an identity of a producer of the audio signal.
